(19) United States
(12) Patent Application Publication
(10) Pub. No.: US 2025/0023045 A1
(43) Pub. Date: Jan. 16, 2025

(54) SYSTEMS AND METHODS FOR MESOPHASE PITCH STRUCTURAL CONTROL AND COMPOSITIONAL ANALYSIS USING MAGNETIC FIELDS

(71) Applicants: ExxonMobil Technology and Engineering Company, Annandale, NJ (US); The Trustees of the University Of Pennsylvania, Philadelphia, PA (US)

(72) Inventors: Manesh Gopinadhan, Basking Ridge, NJ (US); Stuart E. Smith, Easton, PA (US); Eric B. Sirota, Flemington, NJ (US); Bharath Natarajan, Basking Ridge, NJ (US); Chinedum O. Osuji, Gladwyne, PA (US); Yuma Morimitsu, Fukuoka (JP); Kazem V. Edmond, Lebanon, NJ (US)

(21) Appl. No.: 18/349,227

(22) Filed: Jul. 10, 2023

(51) Int. Cl. H01M 4/583; H01M 4/62; H01M 10/0525

(52) U.S. Cl. CPC H01M 4/583; H01M 4/622; H01M 4/625; H01M 10/0525; H01M 2004/021; H01M 2004/027

(57) ABSTRACT

Disclosed embodiments may include a material having a composition including a mesophase pitch material between approximately 5.0% to 95.0% and having a viscosity of between approximately 0.01 to 10² Pascal seconds (Pa·s) in a temperature range of between approximately Tₛ<T≤475° C., where Tₛ≥150° C. At least a portion of the mesophase pitch material may be aligned by a magnetic field having a strength of approximately 0.25 to 6.0 Tesla. The portion of the mesophase pitch material may have an average molecular spacing of between approximately 3.4 to 3.7 angstroms, and an average molecular size of between approximately 1 to 3 nanometers (nm).

### FIELD

The present application relates to systems and methods for mesophase pitch structural control and compositional analysis using magnetic fields.

### BACKGROUND

Molecules in heavy hydrocarbon feeds (e.g., main column bottoms, steam cracker tar, vacuum residue, etc.) generally include multi-ring aromatics with small side groups. Isotropic pitches can be isolated from these heavy streams through pyrolysis and/or various separations, such as solvent extraction, distillation, etc. Disordered heavy hydrocarbon rich isotropic pitch may be transformed to an ordered, “mesophase” pitch (discotic nematic phase) through thermal and/or catalytic routes which can be further assisted by solvent extraction. Pitch pyrolysis is an energy intensive process, and new cost-effective approaches are sought to control the mesophase transformation rate and texturing thereafter.

Accordingly, there is a need for improved systems and methods for mesophase structural control and compositional analysis using other methods, such as magnetic fields.

### SUMMARY

Disclosed embodiments may include a material. The material may include a composition including a mesophase pitch material of between approximately 5.0% to 95.0% and having a viscosity of between approximately 0.01 to 102 Pascal-seconds (Pa·s) in a temperature range of between approximately Tₛ<T≤475° C., where Tₛ≥150° C., where Tₛ is denoted as the softening point of the pitch. At least a portion of the mesophase pitch material may be aligned by a magnetic field having a strength of approximately 0.25 to 6.0 Tesla (T). The portion of the mesophase pitch material may have an average molecular spacing of between approximately 3.4 to 3.7 angstroms (Å) in the stacking direction, and an average molecular size of between approximately 1 to 3 nanometers (nm) in the lateral direction.

Disclosed embodiments may include a method for controlling the alignment of mesogenic molecules in a composition. The method may include providing the composition including a mesophase pitch material of between approximately 5.0% and 100.0% and having a viscosity of between approximately 0.01 to 102 Pa·s in a temperature range of between approximately Tₛ<T≤475° C., where Tₛ≥150° C. The method may include applying a magnetic field of between approximately 0.25 to 6.0 T to the composition thereby resulting in at least a portion of the mesophase pitch material being aligned by the magnetic field within approximately 0.1 to 104 seconds. The portion of the mesophase pitch material may include a plurality of mesophase droplets having a minimum droplet diameter of approximately 50 nm.

Disclosed embodiments may include a pitch material. The material may include a composition including a mesophase pitch material of between approximately 5.0% to 95.0% and having a viscosity of between approximately 0.01 to 102 Pa·s (e.g., above the softening point of pitch). At least a portion of the mesophase pitch material may be aligned by a magnetic field in the presence of the magnetic field of between approximately 0.5 to 2.0 T at a temperature of between approximately Tₛ<T≤450° C., where Tₛ≥150° C., and within approximately 0.1 seconds to 50 minutes.

These and other features and attributes of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIGS. 1A-1B illustrate orienting a mesophase pitch using a magnetic field (A) with the mesogen director of the discotic being oriented in the XY plane (field along z-axis), and (B) by rotating either the sample or the magnetic field to obtain a unique average director orientation (along X or −X), in accordance with certain embodiments of the disclosed technology.

FIGS. 2A-2C illustrate (A) size of the mesophase pitch droplet (diameter) required to align in different magnetic fields as a function of magnetic anisotropy (aromaticity), (B) time scale of alignment above the threshold size of the droplet for 4-membered aromatic material (e.g., triphenylene) at different viscosities, and (C) comparison of alignment time scale for a 4-membered ring and a 7-membered ring, in accordance with certain embodiments of the disclosed technology.

FIG. 3A provides a flowchart of isotropic pitch production from SOP2 tar feed, in accordance with certain embodiments of the disclosed technology.

FIGS. 3B-3D provide optical micrographs (top: cross-polarized light image; and bottom: corresponding fluorescent light image) of pyrolyzed pitch samples for 30 min (3B), 60 min (3C) and 90 min (3D) at 400° C., measured at room temperature.

FIGS. 4A-4D illustrate different scenarios where the magnetic orientational control of pitch systems can be attained (A) during pyrolysis when the mesophase droplet size exceeds the threshold volume needed to surpass the thermal fluctuations, and (B-D) in pre-made mesophase systems by heating above the T_{g} of the isotropic or mesophase, in accordance with certain embodiments of the disclosed technology.

FIGS. 5A-5G illustrate (A) sample preparation of SOP2 tar material in the presence or absence of magnetic field. (B) 2D scattering pattern of the as-received isotropic powder material, (C-D) x-ray scattering pattern of the samples from FIG. 5A. (E) intensity profiles of the scattering data against scattering vector, q. (F) polarized light micrographs of the as-received material, depicting isotropic phase surrounded by an epoxy mounting medium, and (G) material after heating at 400° C. for 30 min leading to approximately 20% mesophase content, depicting liquid crystalline mesophase droplets surrounded by isotropic material, in accordance with certain embodiments of the disclosed technology.

FIGS. 6A-6F illustrate room temperature data of, (A) magnetic alignment experiments of sample (i) and sample (ii) under 6 T magnetic field, (B-E) corresponding 2D X-ray data, and (F) azimuthal intensity profiles of high angle reflection q˜1.8 Å⁻¹, at 6 T after annealing the samples isothermally for 30 min at 300° C. and subsequently at 400° C. for 10 min, 30 min, 60 min, respectively, in accordance with certain embodiments of the disclosed technology.

FIGS. 7A-7G illustrate room temperature data of, (A) magnetic alignment experiments of sample (i) and sample (ii) under a 1 T magnetic field, (B-E) corresponding 2D X-ray data (at 300° C. for 30 min, at 400° C., 30 min, 60 min, 90 min), (F) intensity plotted against scattering vector, q, and (G) azimuthal intensity profiles at high angle reflection q˜1.8 Å⁻¹, at 1 T neat sample and after annealing the samples isothermally for 0 min to 30 min at 300° C. and subsequently for 30 min and 60 min at 400° C., in accordance with certain embodiments of the disclosed technology.

FIGS. 8A-8C provide optical micrographs of a non-aligned mesophase pitch sample at different sample rotations, in accordance with certain embodiments of the disclosed technology.

FIGS. 9A-9C provide cross-polarized light micrographs of a magnetically aligned mesophase pitch sample obtained at different sample orientations relative to cross-polars, in accordance with certain embodiments of the disclosed technology. The arrows indicate the magnetic field's direction relative to the sample's orientation.

FIG. 10 illustrates 2D X-ray scattering pattern obtained at room temperature indicating fast response of mesophase pitch material under a 6 T magnetic field. First, two sets of mesophase samples were prepared by heat treating the original pitch at higher temperatures in the absence of magnetic field. The first set of samples were prepared by isothermally holding for 30 min at 300° C. And the second set was prepared by isothermal heating at 300° C. for 30 min and subsequently isothermally heating at 400° C. for another 30 min. After sample preparation, two sets of samples were subjected to a 6T magnetic field at 400° C. for 1 min and 5 min, respectively.

FIGS. 11A-11D illustrate (A) a composite material with mesophase pitch, (B) droplets of the mesophase pitch with their discotic director aligned normal to the applied magnetic field, and (C-D) the director orienting uniaxially when the magnet (or sample) is rotated, in accordance with certain embodiments of the disclosed technology.

FIG. 12 illustrates a composite material containing carbon nanotubes (CNTs) and mesophase pitch, in accordance with certain embodiments of the disclosed technology.

FIGS. 13A-13B illustrate a combinatorial approach to obtain highly aligned thin film samples using surface induced alignment combined with magnetic alignment (A) when the mesogens are aligned in plane relative to the surface, and (B) using additional surface confinement, in accordance with certain embodiments of the disclosed technology.

FIGS. 14A-14B illustrate (A) 2D x-ray scattering pattern measured at room temperature, and (B) Gaussian fitting to the azimuthal intensity profile of the high angle reflection at ˜1.8 Å⁻¹, in accordance with certain embodiments of the disclosed technology.

FIGS. 15A-15B provide (A) alignment quality as a function of depth (vertical axis) for different annealing times (horizontal axis), and (B) the bulk mesophase fraction estimated by expression (3) for different heights along the capillary, in accordance with certain embodiments of the disclosed technology.

FIG. 16 illustrates an example scheme for inducing alignment of mesophase molecules in articles (e.g., fibers) during extrusion or 3D printing, in accordance with certain embodiments of the disclosed technology.

### DETAILED DESCRIPTION

Molecules in heavy hydrocarbon feeds (e.g., main column bottoms, steam cracker tar, vacuum residue, etc.) generally include multi-ring aromatics with small side groups. Isotropic pitches can be isolated from these heavy streams through pyrolysis and/or various separations, such as solvent extraction, distillation, etc. Above glass transition temperature (T_{g}), the isotropic pitch flows like a liquid, becoming more viscous at lower temperature and becomes glassy below T_{g}. A discotic mesophase can be formed upon thermal or catalytic (or thermo-catalytic) treatments, due to chemical and structural transformations taking place within the material due to these processes. The chemical transformations may include chain (side groups) cleavage, condensation, cyclization (ring-closure), and/or dehydrogenation reactions leading to more condensed aromatic molecules. Increased planarity and aromaticity generally lead to higher mesogenic (liquid crystalline) nature for these materials. Concurrent with these chemical reactions, off gassing of volatiles and reaction products lead to an increase in the overall viscosity of the system at a constant temperature during pyrolysis. Increase of mesogenic content due to chemical reactions and removal of low boiling components leads to phase separation of mesogenic molecules from the isotropic phase of mesogenic and non-mesogenic molecules, that self-assemble to form an ordered liquid crystalline discotic nematic mesophase, which is mainly mediated via aromatic-aromatic π-π as well as steric interactions. The isotropic-Nematic transition temperature (T_{IN}) in pitches during thermal treatment depends on the extent of chemical reactions (chemical severity). During thermal treatment (e.g., isothermal soaking above the softening point Tₛ of the material), T_{IN} increases because of continual change in pitch composition, i.e., increase in number density of larger and planar aromatic (more mesogenic) molecules, stronger intermolecular interactions (cohesive energy density) are favored, thus resulting in an increase in the solubility parameter.

When an isotropic material is subjected to pyrolysis at T_{pyrolysis}, mesophase droplets can be first observed with a cross-polarized light microscope when the clearing transition temperature (i.e., temperature at which the nematic phase becomes isotropic liquid, hence finite order parameter becomes zero) T_{C}=T_{pyrolysis}. When the material transitions into the nematic state, the mesophase droplets can couple to and align with an external magnetic field, and the time scale of alignment can be further assisted by the lower viscosity of the surrounding isotropic medium. However, since viscosity of the material increases with pyrolysis time at an alignment temperature, this would act to slow the kinetics of magnetic alignment. However, increase in aromaticity with time (thermal severity) leads to an increase in magnetic anisotropy of the system, which decreases the time scale of magnetic alignment, hence causing an effect favoring speeding of alignment. Accordingly, the mesophase pitch alignment kinetics is determined by the balance between these two effects. Mesophase droplet appears when T_{C}=T_{pyrolysis}, but as chemistry proceeds, the clearing temperature T_{C} of those droplets continues to increase due to molecular weight growth, so the earlier the mesophase is formed, the higher will be T_{C}. Therefore, an in situ magnetic alignment procedure during pyrolysis of an isotropic pitch may be more suitable to attain a higher fraction of mesophase aligned in registry with the magnetic field.

During pyrolysis, the newly formed mesophase droplets align with the magnetic field when their size exceeds a threshold size prescribed by the magnetic anisotropy and the field strength. Hence, during the nucleation and growth of the droplets, they are aligned by the magnetic field, and continue to maintain the orientation while increasing their size due to further growth. However, this effect also depends on the composition of matter, for instance if a higher mesophase content material has an accessible clearing temperature, fast alignment may be achieved for that composition by cooling across isotropic-nematic transition temperature. If the clearing temperature is not accessible, and if the system has low enough viscosity (e.g., 1-10 Pa·s) at higher temperatures well above the softening point, alignment of the mesophase can be attained at reasonably fast time scales (e.g., seconds to minutes). The mesophase transformation kinetics which in turn depends on the composition of the pitch plays a crucial role on magnetic alignment time scales.

The performance (e.g., mechanical, electrical, or thermal) of mesophase pitch-based carbon fibers or other carbon materials is ultimately dictated by the microdomain texture and the graphitic domain size, where the former is largely determined by mesogen orientation due to spinneret die geometry or processing conditions (temperature or sparging inert gas). Therefore, controlling the microstructure of the precursor mesophase pitch materials during processing allows for performance enhancements of carbon materials formed thereof. To this end, control of mesophase director orientation in the bulk is an essential step defining the material properties for a given application. Hence, a method of measuring the mesophase content in the bulk is desirable for defining the pitch product specification prior to and after the manufacturing steps.

Disordered heavy hydrocarbon rich isotropic pitch may be transformed to an ordered, “mesophase” pitch (discotic nematic phase) through thermal and/or catalytic routes which can be further assisted by solvent extraction. Pitch pyrolysis is an energy intensive process, and new cost-effective approaches are sought to control the mesophase transformation rate and texturing thereafter. The mesophase pitch as spun green fibers (as spun mesophase pitch fibers prior to further processing) produced through melt spinning undergo additional steps, e.g., stabilization, carbonization before gaining structural attributes in the form of a high-modulus, high-strength carbon fiber via the final graphitization step. This final step may be performed at high temperatures (e.g., >2000° C.) to form carbon fibers, thus attaining high performance properties.

For pitch-based carbon fibers or other pitch-based carbon composite materials, the properties (e.g., mechanical, electrical, thermal, etc.) are determined by the mesophase content in the precursor material, crystallite size of the graphitic domains and their geometrical configurations within the resultant carbon fiber (texture of the fiber). The performance (e.g., mechanical, electrical, or thermal) of mesophase pitch-based carbon fibers is ultimately dictated by the microdomain texture and the graphitic domain size, where the former is largely determined by mesogen orientation in the as-spun green fiber due to spinneret die geometry or processing conditions (e.g., temperature or sparging inert gas). Therefore, the subsequent graphitic structure and morphology are strongly correlated to the molecular orientation obtained in the green carbon materials prior to high temperature treatments. Irregular and random spatial arrangements of mesophase domains may lead to small grain size, structural defects including void formation or micro-porosity in the final carbon material, deteriorating the high performance. Due to high crystallinity and graphitic orientation, the mesophase pitch carbon fibers also suffer lower tensile strength in comparison to polyacrylonitrile (PAN) based carbon fibers. Typically, when the green fiber is extruded, temperature and spinneret die geometry are frequently varied to tune the texture of the fibers, which helps to optimize the tensile strength of the carbon fibers while compromising mechanical modulus (or thermal and electrical properties) for various applications. Thus, there is a strong need for novel methods to control the internal morphology of the fibers or other carbon articles, thereby tuning the structural and physical properties of various carbon forms.

In typical systems and methods for orientation control, mesophase molecules tend to orient along the direction of flow or when subjected to external fields (e.g., magnetic) or surface fields (surface induced orientation). Since mesophase pitch materials are highly aromatic in nature, higher magnetic anisotropy combined with lower viscosity afforded by high temperatures could be advantageously used to align mesophase materials with low intensity magnetic fields. A hydrocarbon feed that already has a significant fraction of polynuclear aromatics may provide a faster response in low intensity magnetic fields (e.g., ≤1 Tesla) during the mesophase formation or when subjected to magnetic fields after forming mesophase.

Accordingly, examples of the present disclosure may provide for controlling the mesophase orientation within a pitch material through the application of a magnetic field during the mesophase formation process, or when the pitch is in its molten state. Embodiments of the present disclosure may provide for controlling of the ordering, orientation, morphology (texture), and/or domain size of the mesophase itself, which may affect properties of the final carbon products.

For example, embodiments of the present disclosure focus on the utilization of magnetic fields to control the orientational ordering of the mesophase during the phase transformation in mesophase pitch materials or in other carbon articles (e.g., composites). Further, magnetic field patterns may also be used to control the geometric alignment of mesophase domains or droplets in the fibers or in composite materials with high fidelity, wherein in the latter case mesophase either forms the minority (filler) or majority (matrix phase). The composite material may also include CNT/mesophase pitch composites, matrix material with CNTs, or other high aspect ratio carbon materials. In thin film geometry, concurrent application of magnetic fields together with surface anchoring effects of discotic molecules in the pitch could be used to create highly aligned mesophase precursors to generate large graphitic sheets (2D materials) or ribbons. Thus, magnetic field induced structural control of mesophase pitches using permanent or by electro-magnets may provide for additional handling on carbon fiber texturing when applied to melt fiber spinning or 3D printing of mesophase pitches, which can be transformed into larger and highly oriented graphitic domains in the resulting carbon materials after high temperature treatments (e.g., stabilization, carbonization, graphitization). Strong anisotropic ordering or texturing in mesophase pitches of various forms at reasonable time scales opens up the possibilities of fabrication of advanced carbon products with higher performance attributes, such as lithium-ion battery anodes, graphite materials, etc. Additionally, embodiments of the present disclosure demonstrate a novel approach to quantify the mesophase content in the bulk material by alignment of mesophase domains (droplets) under magnetic fields.

Mesophase pitch includes large aromatic disc-like molecules, possessing weak diamagnetism, with the easy axis lying in the aromatic plane. Therefore, these discotic systems are expected to orient in the presence of an external magnetic field (B) when the thermodynamic (ΔX, grain size) and kinetic conditions (lower viscosity enables faster response) are met, and the applied field (B) is above the threshold field needed to observe the alignment of mesophase droplets (or fraction) at practical time scales (seconds to min). Typically, the kinetics of mesogen formation in pitches is a slow process and it may take up to several hours to form approximately 50% mesophase content when an isotropic pitch is subjected to pyrolysis. However, embodiments of the present disclosure provide a pitch composition of matter that forms mesophase in less than approximately 30 minutes at higher temperatures (e.g., 400° C.), which is beneficial for in situ pyrolysis under magnetic fields. In addition, embodiments of the present disclosure provide a scenario wherein the starting pitch material includes a significant fraction of mesogenic molecules, which drives the alignment to occur in a period of seconds to minutes, depending on the operating conditions (e.g., temperature, viscosity, magnetic field strength, and the aromatic size).

The thermodynamic condition is given as:

$$Δ {E}_{m} ( θ , B ) = - {B}^{2} / 2 {μ}_{0} ( {Δχξ}^{3} {cos}^{2} ( θ ) ) > {K}_{B} T \qquad ( Equation 1 )$$

where ΔX=X_{∥}−X_{⊥} is the diamagnetic anisotropy (difference between diamagnetic susceptibilities parallel, X_{∥}, and perpendicular directions, X_{⊥}).

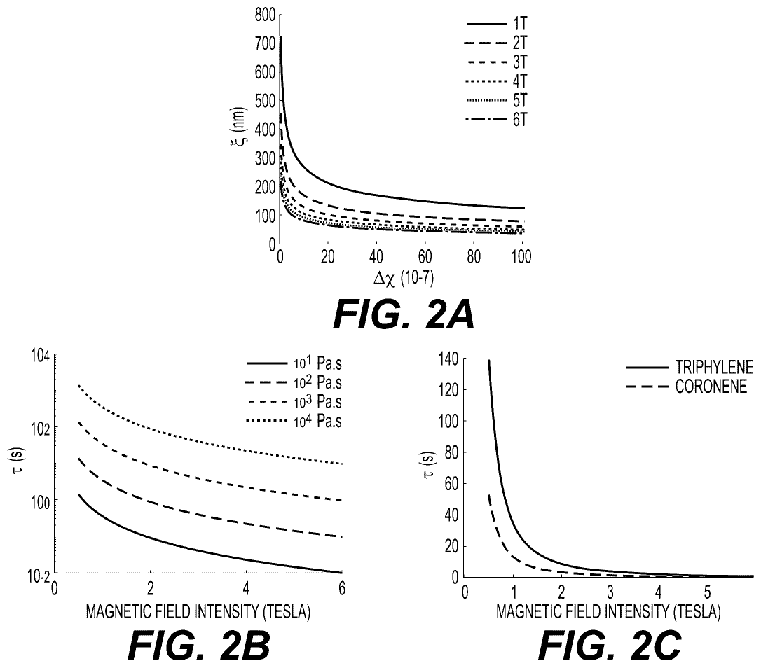

As the liquid crystal domain size (e.g., droplet size or radius, ξ) increases, the magnetic field intensity required for the alignment decreases for a given ΔX (as discussed further below with respect to FIG. 2A). When the magnetic energy, ΔEₘ, exceeds thermal energy, K_{B}T, the material (e.g., droplet) aligns in the field. The threshold volume is given by:

$${ξ}^{3} \geq \frac{2 {K}_{B} T {μ}_{0}}{Δχ {B}^{2}} \qquad ( Equation 2 )$$

The time τ required for magnetic alignment of a mesophase droplet, which is larger than the critical volume (ξ), depends on the temperature dependent viscosity (η(T)) for a given ΔX and B.

$$τ = {μ}_{0} Δ {χ}^{- 1} 6 η ( T ) {B}^{- 2} \qquad ( Equation 3 )$$

Therefore, the kinetics of alignment depend on the temperature dependent viscosity of the mesophase pitches (as further discussed below with respect to FIG. 2B). Once the mesophase droplet size is above the threshold size, the alignment time scale τ for a given field strength is independent of the volume or size of the droplet provided the viscosity of the surrounding medium is held constant. However, this is not the case for mesophase pitch formation, wherein volatiles come off at higher temperature, in addition to the reaction products. Further, chemical reactions can also lead to increase in molecular mass. Both effects increase the viscosity of the isotropic and anisotropic materials. Therefore, a fast mesophase formation kinetics may be used for purposes of applying this method.

Before the present methods and devices are disclosed and described, it is to be understood that unless otherwise indicated, this invention is not limited to specific compounds, components, compositions, reactants, reaction conditions, linkers, ligands, or the like, as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

All numerical values within the detailed description that are modified by “about” or “approximately” with respect to the indicated value take into account experimental error and variations that would be expected by a person having ordinary skill in the art. In some instances, use of “about” or “approximately” may include a variation of ±10% from the indicated value.

### EXAMPLES

The present disclosure evaluates systems and methods for controlling orientation of molecules in a mesophase pitch material through applying magnetic fields.

### Control of Texture in Mesophase Pitch

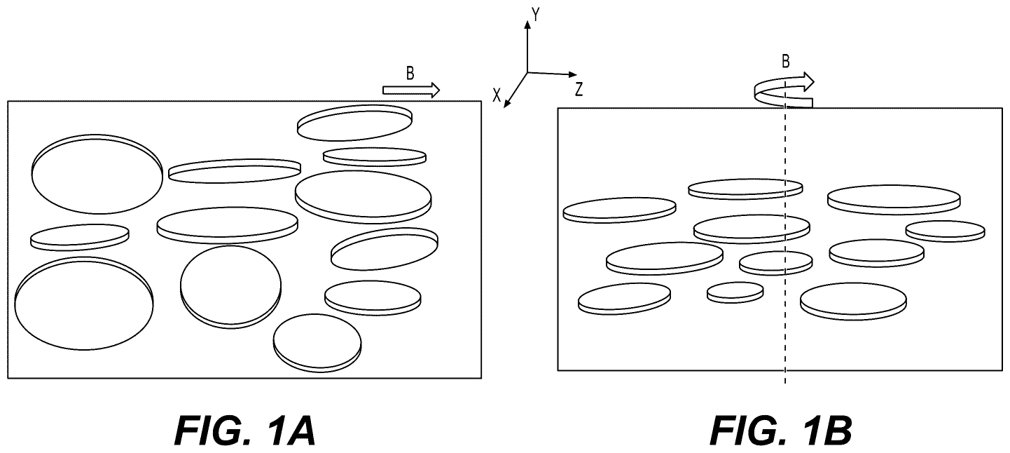

There are two ways in which texture control in mesophase pitches can be obtained. First, during the mesophase synthesis at high temperature, an in situ alignment during pyrolysis, once the mesophase droplet size is higher than the threshold size, the droplet orients with the director vector orienting normal to the magnetic axis. Thus, the aromatic planes can be oriented parallel to the field direction (z-axis), while the optic axis can lie normal to the applied field axis (xy-plane), as illustrated in FIGS. 1A-1B. Specifically, FIG. 1A illustrates how a magnetic field can orient a mesophase pitch material with the mesogen director of the discotic being oriented in the xy-plane (field along the z-axis). Therefore, there is degeneracy associated with the orientation of the discotic director. FIG. 1B illustrates that by rotating either the pitch sample or the magnetic field, unique average director orientation (along X or −X) can be obtained, enabling texture control. By rotating the sample in a static magnetic field, the molecular layers can be oriented uniaxially relative to the field direction. In situ alignment during pyrolysis may permit alignment of higher concentration of mesophase, if the mesophase formation kinetics is faster and a homogenous nucleation takes place—thus nearly all droplets will be aligned. This method may be used for applications that require high degree of aligned mesophase materials.

Second, alignment of mesophase pitch can be achieved as the material is heated to higher temperatures above the glass transition temperature of the isotropic fraction (T_{g, iso}) or mesophase fraction (T_{g}, meso) depending on the volume fraction of each phase in the mesophase pitch material. Depending on the droplet size (or the mesophase content) and the viscosity of the material, magnetic alignment time may differ (Equation 3). If the majority phase is isotropic, mesophase droplets align if the material is heated above the softening point. Tₛ and the kinetics will be faster in comparison to the situation where the mesophase forms majority phase. Due to higher aromaticity of the mesogenic species and molecular order, the mesophase part has higher viscosity than the isotropic part. Therefore, alignment of the pre-formed mesophase with isotropic fraction forming the continuous phase may provide faster rate of mesophase structural control for applications that necessitate high-throughput processing.

### Mesophase Formation Kinetics in Pitch

Typically, kinetics of mesogen formation is rather slow in pitch systems during pyrolysis at higher temperatures (e.g., 400° C.). Therefore, to achieve high mesophase content (e.g., greater than approximately 50 vol %), the isotropic material has to undergo pyrolysis for several hours which can be energy intensive. The mesophase transformation rate depends on the composition of the original feed material in addition to processing steps. Longer heat treatment can also lead to higher molecular weight materials, which can result in higher viscosity. This may adversely affect the magnetic alignment kinetics as well (e.g., some regions may not be aligned), or require intense magnetic fields (e.g., greater than approximately 2 T) to impose uniform alignment of the material.

As illustrated in FIGS. 2A-2C, larger aromaticity and mesophase droplet size affect the thermodynamics of alignment, while the alignment kinetics depend on the viscosity of material at the operating temperature. Specifically, FIG. 2A illustrates the threshold size of the mesophase pitch droplet (diameter) required to align in different magnetic fields as a function of magnetic anisotropy (aromaticity). FIG. 2B illustrates a time scale of magnetic alignment above the threshold size of the droplet for a triphenylene system, i.e., a four-membered aromatic species (ΔX being approximately 10⁻⁴, dimensionless SI units) at different viscosities. As shown, the mesophase pitch material can have a viscosity between approximately 0.1 to 10² Pa·s (e.g., between approximately 0.25 to 50 Pa·s) when heated above its softening point, under the presence of a magnetic field having a strength of approximately 0.25 to 6.0 T (e.g., approximately 1.0 T. 2.0 T, 3.0 T, 4.0 T, 5.0 T, etc.) in order to achieve alignment. As discussed herein, the mesophase pitch material may be heated to within a temperature range of approximately Tₛ<T≤475° C. (e.g., between approximately 200° C. to 475° C., or between approximately 300° C. to 475° C.) when subjected to the magnetic field in order to achieve proper alignment. Further, as discussed herein, heating the sample to above its softening point (Tₛ), such as to approximately 20° C. to 150° C. above Tₛ, may help to achieve greater degree of alignment. FIG. 2C provides a comparison of an alignment time scale for a 4-membered versus a 7-membered aromatic ring.

### Mesophase Pitch Material

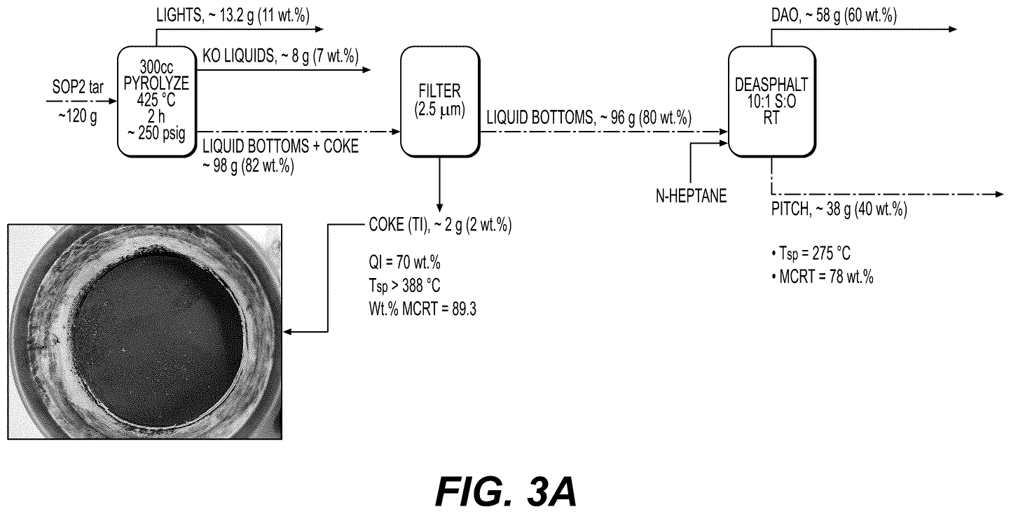

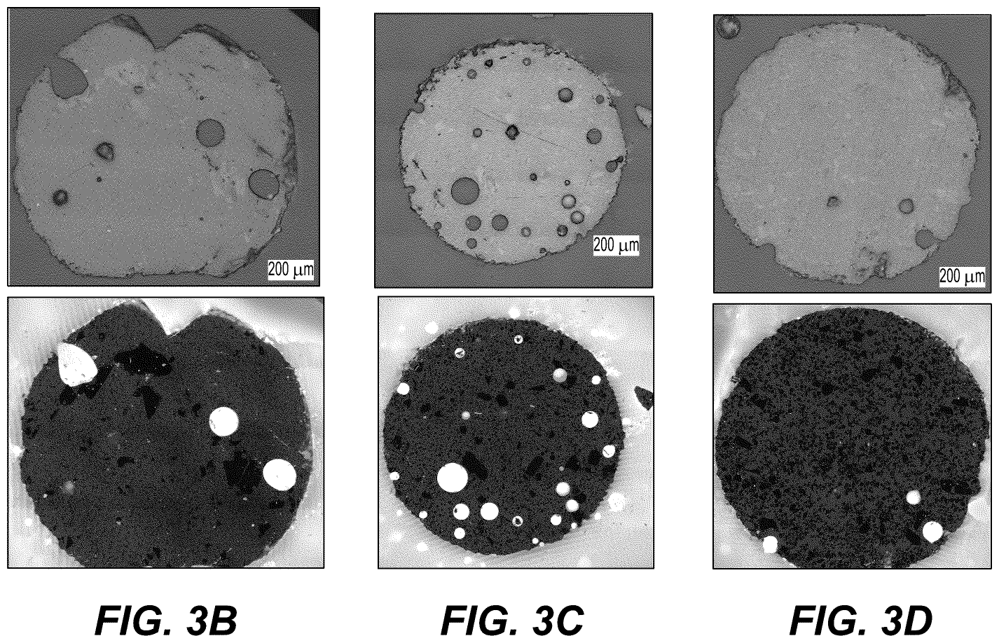

The present disclosure provides a composition of matter that already contains large fraction of aromatic molecules with mesogenic character, so that alignment can be done at lower temperatures and/or shorter times. FIG. 3A provides a flowchart of producing such pitch material, specifically isotropic pitch production from SOP2 tar feed. As shown, SOP2 tar feed, which was prepared by steam cracking, and was heat treated at 25° C. for 2 hours under 250 psi pressure under a constant flow of hydrogen to remove the light molecules and collect the liquids in a knockout pot (KO). The liquid bottoms remaining in the autoclave (having a yield of approximately 82%), was filtered while hot using a 2.5-micron filter to remove the coke fraction, which was found to be approximately 2%. The filtered liquid bottoms material was subsequently de-asphalted with n-heptane to remove the DAO (de-asphalted oil). The insoluble fraction is the isotropic pitch. The overall yield of the final product is approximately 40%. The resulting pitch has a softening point. Tₛ, of approximately 275° C., and a micro carbon residue test (MCRT) of approximately 78%. In some embodiments, the MCRT may be greater than approximately 40%.

The original pitch material obtained from the above process when subjected to heat treatment shows the appearance of birefringent droplets indicating the formation of mesophase in the material. Since mesophase is optically birefringent, reflected cross-polarized light is used to highlight the mesophase regions from the isotropic part. Additionally, fluorescent light imaging is used here to quantify the mesophase content. The π-π interactions between neighboring planar aromatic molecules in the mesophase enable energy transfer, inter- or intramolecular charge transfer, resulting in fluorescent quenching, producing high contrast images that dramatically simplify the segmentation and quantification of the two phases. Using a standard pixel-intensity thresholding algorithm, the fluorescent light images were segmented to compute the area fraction of mesophase present in the samples. The cross-polarized light images were acquired using a waveplate, a specific birefringent crystal, shifting the phase of the polarized light components by ˜532 nm known as a full waveplate, significantly enhancing the image contrast, making all phases uniquely visible, as depicted in FIGS. 3B-3D. In the cross-polarized gray scale images, the isotropic phase appears as lighter gray while the epoxy-filled regions would appear as deep gray and the mesophase regions appear as brighter. Meanwhile, fluorescent light imaging depicts the epoxy as brighter (highly fluorescent), due to the addition of a dye, whereas the isotropic phase appears gray, while the mesophase, which quenches most emissions due to a high degree of discotic ordering, appears darker. FIGS. 3B-3D indicate an increase in the mesophase content from 20%, 27% and 35% for different heat treatment times of 30 min, 60 min, and 90 min at a chosen temperature 400° C.

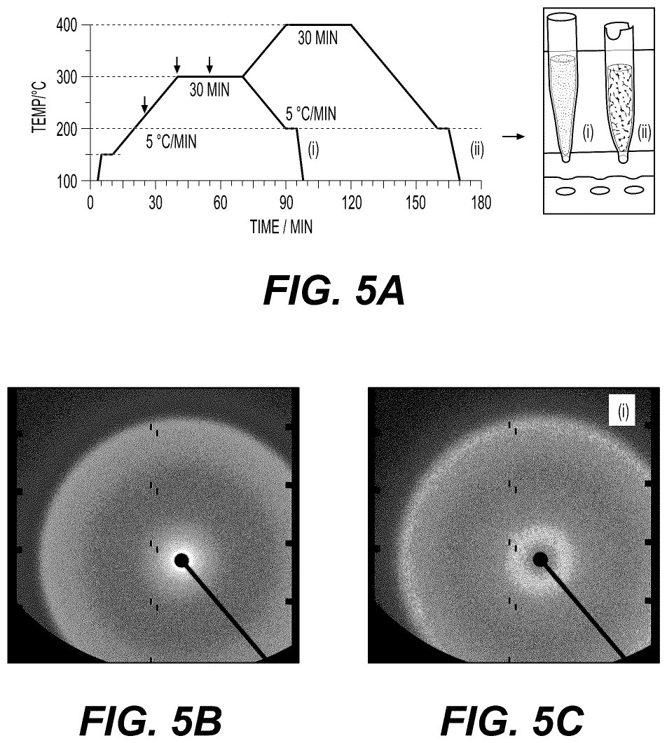

The as-prepared non-heat treated (isotropic material) powder shows a high angle d(002) reflection of approximately 3.5 Å (as discussed further below with respect to FIGS. 5A-5G), a typical scattering peak position seen for mesophase pitches due to stacking of planar aromatic molecules, wherein the molecules have a higher C/H ratio and thus more aromaticity and/or planar nature (discotic). Polarized optical microscopy measurements (FIG. 5F) indicate very weak birefringent domains in the original material, indicating lack of strong mesophase ordering in the system. After annealing above the softening point at 300° C. (Tₛ=275° C.), the small angle peak at 2 nm, which originates from the average separation between the molecules, is pronounced. The higher intensity in the original powder material is presumably originating from scattering contrast due to voids, which disappears after annealing above Tₛ. The original material may lack strong orientational order and long-range order, presumably due to the de-asphalting step using n-heptane, which might lead to structural arrest. Therefore, an increased order after annealing above the Tₛ of the material may be obtained.

### Magnetic Orientational Control of Pitch Systems

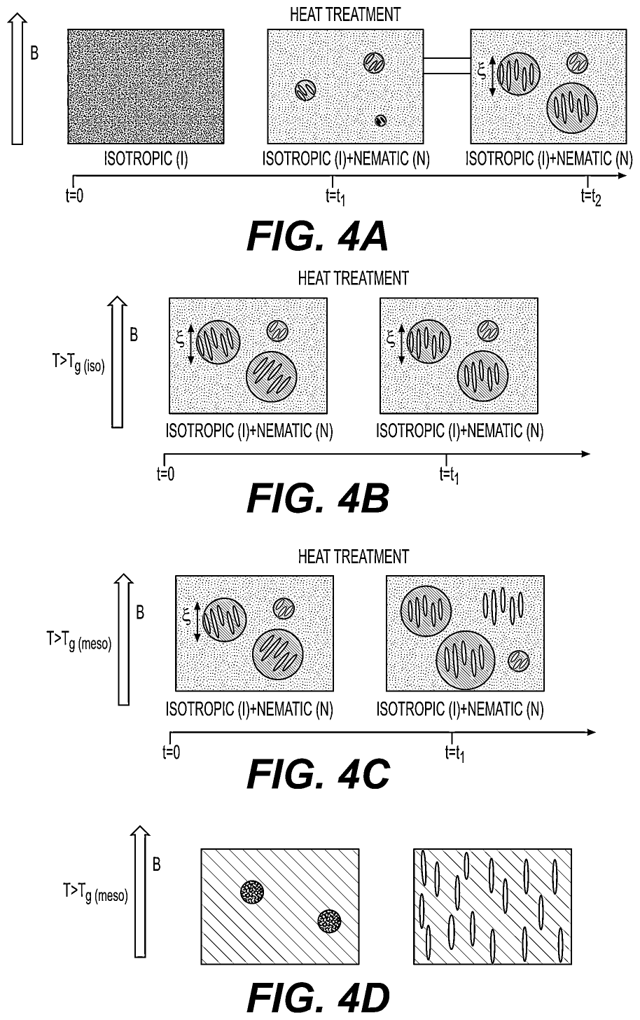

FIGS. 4A-4D provide different scenarios where the magnetic orientational control of pitch systems can be attained. FIG. 4A illustrates that during pyrolysis when the mesophase droplet size exceeds the threshold volume needed to surpass the thermal fluctuations, the droplets will align. As shown in FIGS. 4B-4D, pre-made mesophase systems can be aligned by heating above the T_{g} of the isotropic or mesophase. The time scale of alignment depends on the temperature dependent viscosity and the composition of matter (diamagnetic anisotropy or aromatic size). These experiments need be conducted under inert conditions or vacuum.

As shown in FIGS. 4A-4D, there are different ways to align a mesophase pitch using such methods. One way may be to heat the material to higher temperatures (e.g., approximately 400° C.) using a reasonable ramping rate (e.g., 0.5° C./min to 20° C./min). Another way may be to isothermally heat soak the material at a higher temperature (e.g., 350° C. or above) while subjecting to a magnetic field, which allows magnetic alignment of mesophase droplets formed during chemical reactions. This method thus offers to do chemistry and simultaneous control of the director orientation of the mesophase formed with time. The latter approach thus allows for aligning higher fraction of mesophase material (>50%) with a magnetic field with a short period of time.

### Results & Analysis of the Mesophase Pitch Material

FIGS. 5A-5G illustrate data obtained through analysis of the above-described pitch material, as described with respect to FIG. 3A. FIG. 5A provides an experimental protocol used to make samples for magnetic alignment studies. Sample (i) was isothermally heated at 300° C. for 30 min, and subsequently isothermally heated at 400° C. for 30 min to produce sample (ii) (both in the absence and presence of magnetic fields). FIG. 5B provides a 2D scattering pattern of the as-received isotropic powder material. The random morphology of these samples is evident in the powder scattering pattern. FIGS. 5C and D provide 2D x-ray scattering patterns of samples (i) and (ii). After heating the samples, the signature reflection at q˜1.8 Å⁻¹ that corresponds to the T-R stacking distance, d(002)˜3.5 Å increases in intensity while the medium angle peak that is indicative of average lateral spacing at q˜0.35 Å⁻¹ (˜2 nm) is clearly evident. FIG. 5E provides intensity profiles of the scattering data against scattering vector, q. FIGS. 5F and 5G provide polarized light micrographs of the as-received material (FIG. 5F) and the material after heating at 400° C. for 30 min resulting in a mesophase content of approximately 20% (FIG. 5G). The data provided in FIGS. 5B-5G were acquired in the absence of a magnetic field.

Unexpectantly, when the sample was heat treated at 300° C., 25° C. above Tₛ (under N₂) in the presence of a 6 T magnetic field, mesophase orientation was observed, as further discussed below. Presumably, less ordered mesophase (with weak birefringence) formed during solvent de-asphalting step, may evolve to form a well-ordered mesophase above the glass transition temperature when thermally equilibrated. In addition, X-ray scattering can be used to measure liquid crystal order and orientation of sub-micron droplets, which is difficult to resolve under the optical microscope. These submicron droplets are able to orient along the field (with director vector or mesophase droplet poles lying perpendicular to the magnetic field axis) when heated well above the T_{g} or Tₛ of the surrounding material (Tₛ˜275° C.). Therefore, it is anticipated that the original starting material has a significant fraction of mesogenic character (or planar aromatic nature). However, the material is less ordered due to solvent treatment, and becomes more ordered at higher temperature. As the material forms mesophase droplets, they orient in the field when the mesophase droplet size is above the threshold size as stated in Eq. 2. In addition, higher temperature also enhances the mesophase formation kinetics of this material. Thus, a hydrocarbon material that has higher fraction of mesogenic nature leads to a faster rate of mesophase formation, and thus faster orientational control under low intensity magnetic fields (e.g., 1 T to 2 T) can be accomplished at higher temperatures (e.g., 375° C. or 400° C.), with alignment time scales faster than reported in the prior art.

The alignment kinetics was improved at higher temperatures (e.g., at approximately 400° C.), due to reduction in viscosity and faster rates of chemical transformation which leads to the formation of more planar and condensed discotic mesogens. A progression of increase in intensity of the x-x stacking reflection at q˜1.8 Å⁻¹ with time was observed, which is consistent with formation of more discotic mesogens and enhanced kinetics at 400° C. The strong alignment of the liquid crystalline phase is also reflected in the anisotropic reflection of the small angle peak at q of approximately 0.35 Å⁻¹ (lateral molecular spacing approximately 2 nm), which is due to discotic nature of the molecules.

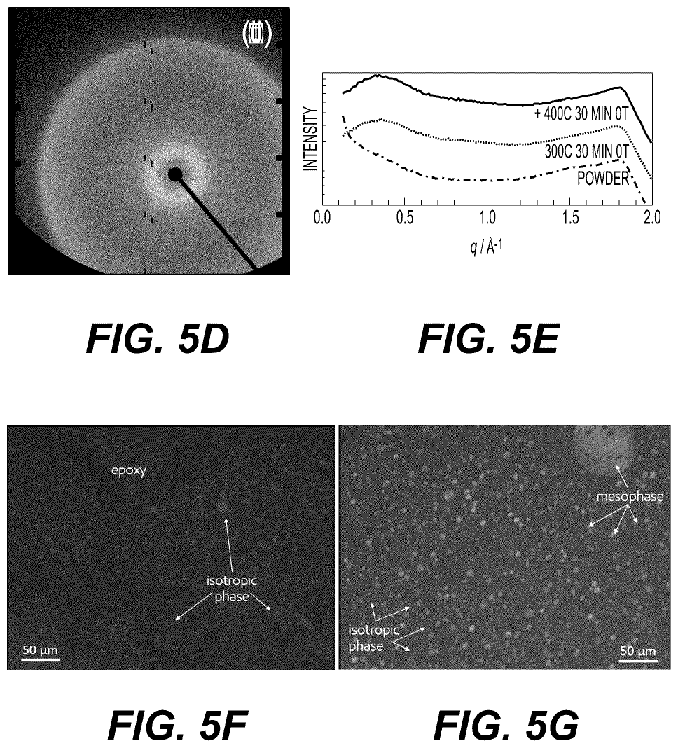

FIGS. 6A-6F illustrate the alignment of the mesophase material in the presence of a magnetic field, specifically of sample (i) and sample (ii) under a 6 T magnetic field. Samples were first annealed at 300° C. for 30 min under 6 T (sample label i) and subsequently heated to 400° C. and isothermally annealed for 10 min, 30 min, and 60 min, respectively. The corresponding 2D X-ray data is shown in FIGS. 6B-6E. FIG. 6F provides azimuthal intensity profiles at high angle reflection of approximately 1.8 Å⁻¹, at 6 T. With increase in process temperature, stronger alignment is observed as reflected from the reduction of full width at half maximum of the π-π stacking reflection. In addition, the background intensity due to randomly aligned structures is diminished with higher processing temperature. Notably, q˜0.35 Å⁻¹ (spacing˜2 nm) which is orthogonal to the π-π stacking reflection shows improved ordering with temperature and time. The intensity of the π-π stacking reflection also increases marginally with processing time at 400° C. All this data indicates that pyrolysis leads to more mesophase content, and population of mesophase oriented in the field prescribed by the magnetic anisotropy of the material increases as a result.

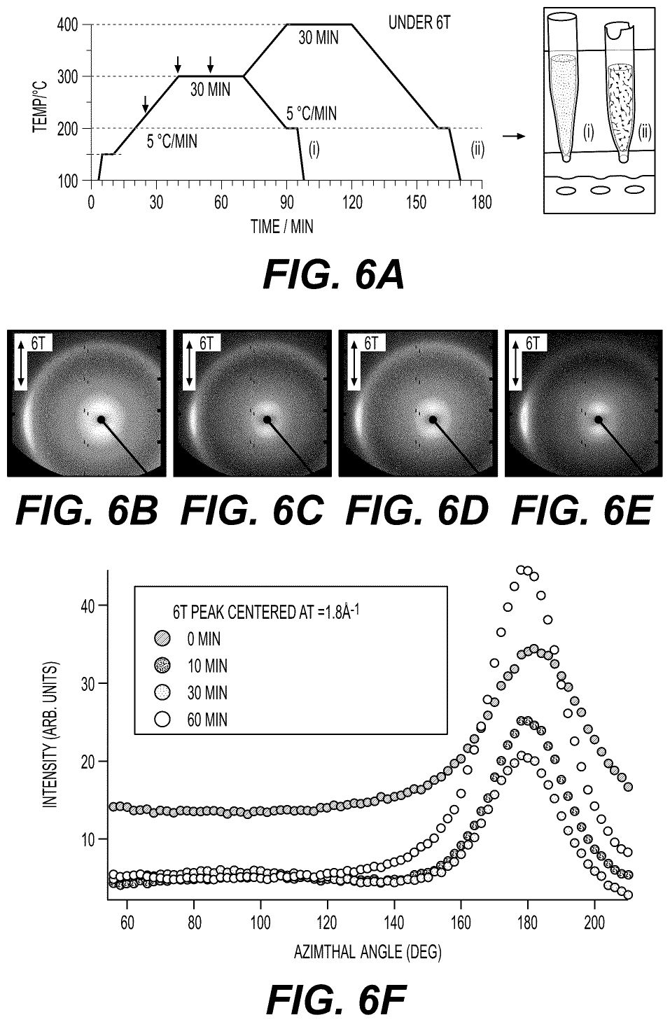

FIGS. 7A-7G illustrate the alignment of the mesophase material in the presence of a magnetic field, specifically of sample (i) and sample (ii) under a 1 T magnetic field. As shown in FIG. 7A, samples were first annealed at 300° C. for 30 min under 1 T (sample label i) and subsequently heated to 400° C. and isothermally annealed for 0 min, 30 min, 60 min, and 90 min, respectively. The corresponding 2D X-ray data is shown in FIGS. 7B-7E. FIG. 7F provides intensity plotted against scattering vector q. FIG. 7G provides azimuthal intensity profiles at high angle reflection of approximately 1.8 Å⁻¹, at 1 T. The sample annealed at 300° C. did not display alignment within 30 min of processing. However, at higher temperatures stronger alignment of the structures is observed with processing time, consistent with the processing done at 6 T, but with much lesser field strength of 1 T. This shows the feasibility of mesophase pitch structural control even with small magnetic field intensities, that can be generated by permanent magnets or electromagnets. Also, the background intensity reduction in the azimuthal profile in FIG. 7G suggests increase in fraction of the aligned mesophase with time, which is also originating from increase in mesophase fraction as chemical reaction proceeds.

Magnetic alignment experiments conducted at lower field strengths (1 T), did not show notable mesophase alignment of the material at 300° C. (for 30 min), as shown in FIGS. 7A-7B. However, at higher temperatures, strong alignment of the mesophase with the field was observed, which may be due to three primary factors: (i) lower viscosity at higher temperature; (ii) droplet size increased at higher temperatures, above the threshold volume required for coupling with the 1 T field; and (iii) chemical reactions could be increasing the aromaticity (diamagnetic anisotropy) to an appreciable amount. Another possibility is to produce more mesogenic species at higher temperatures for short duration (e.g., at approximately 425° C. or 450° C. for 5-10 min), then cool to lower temperatures to induce alignment (e.g., at approximately 350° C.). Alternatively, viscosity can also be tuned by adding solvent or de-asphalted oil fraction (DAO) retained in the processing step to enhance the kinetics of ordering at lower temperatures when there is an appreciable amount of mesogens in the system (e.g., between approximately 40-90%). The strong alignment observed at 1 T field strength may indicate that this new composition of matter may be used for structural control of the mesophase pitch fibers or when used in composite applications.

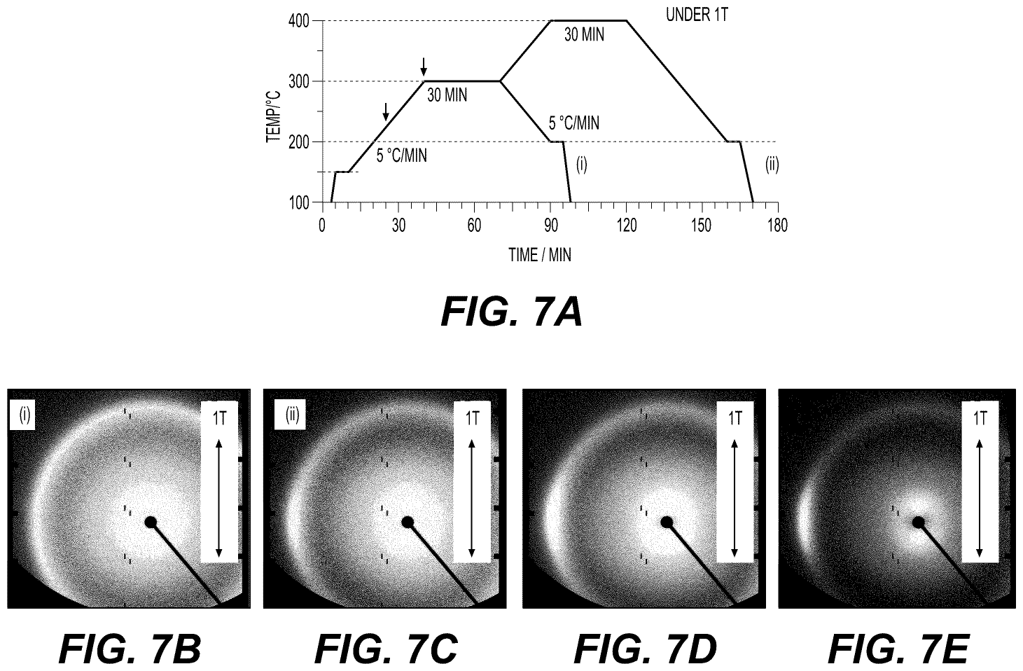

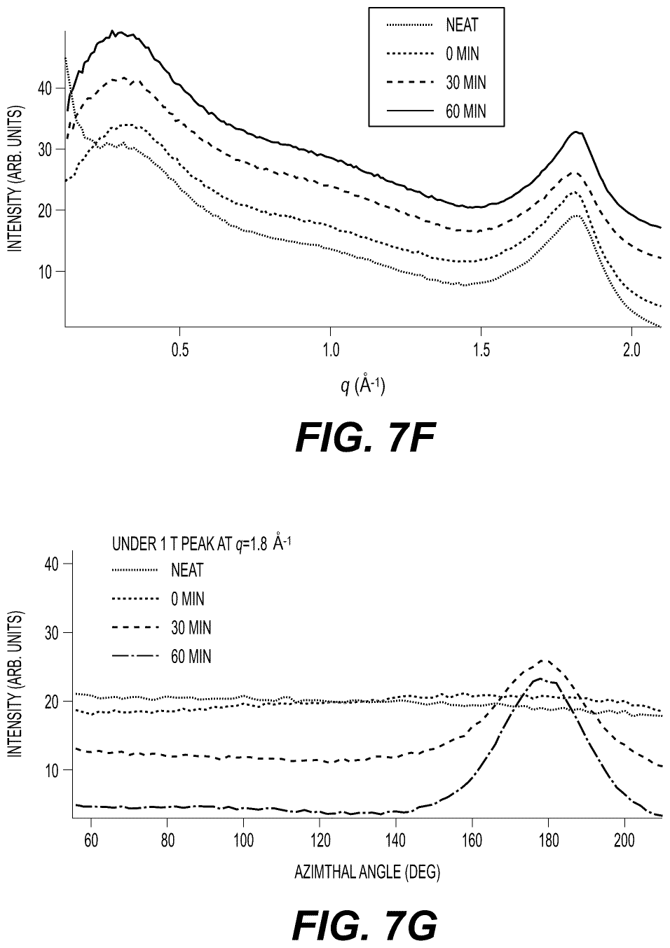

The magnetic response of mesophase pitch materials is also illustrated by polarized light microscopy measurements conducted at room temperature, as shown in FIGS. 8A-8C and 9A-9C. FIGS. 8A-8C provide optical micrographs of a non-aligned mesophase pitch sample-used here as a control sample. The sample was prepared by heating to 300° C. and holding for 30 min, then isothermally heating at 400° C. for 30 min. From FIG. 8A to 8C, the sample was rotated at 45° increments relative to the cross-polarizers. Heat treatment in the absence of magnetic field shows no global orientation of mesophase spheres, as expected. The optical texture of the droplets resembled molecular arrangements reported previously. However, strong optical anisotropy of the droplets was observed when subjected to a magnetic field, as shown in FIGS. 9A-9C. FIGS. 9A-9C provide optical micrographs of a magnetically aligned mesophase pitch sample. The sample was prepared in the presence of a 6 T magnetic field, by heating to 300° C. and holding for 30 min, and subsequently isothermally heated at 400° C. for 30 min and then cooled to room temperature. From FIG. 9A to 9C, the sample was rotated relative to the cross-polarizers, and the magnetic field direction applied to the sample is indicated. It is apparent that the mesogen alignment is mostly uniform in comparison to the non-aligned samples as evidenced from the uniform color and angle dependent optical anisotropy. As shown in FIGS. 9A-9C, the dominant fraction of the mesophase droplets is aligned by the external field prescribed by the magnetic anisotropy of the discotic mesogens. In addition, the data also indicates uniform molecular orientation within most of the droplets, in contrast to the bi-polar texture typical for nematic liquid crystal droplets, which could be due to strong coupling of the mesophase droplets with the magnetic field, overcoming the elastic distortion due to the curvature of the droplets and the anchoring energy of the mesogens prescribed at the interphase. Since the alignment of the discotic director is degenerate normal to the magnetic field axis (FIG. 1A), the viewing direction of some droplets in the images would be along the mesogen director; therefore, in some droplets no change in birefringence is observed. Therefore, data suggests that nearly all the mesophase pitch droplets are oriented with the director vector normal to the field axis while no bi-polar texture is evident in the aligned mesophase droplets.

The application of a permanent magnet to a suspension of mesophase pitch droplets or particles can be magnetically aligned to induce unique anisotropic properties to the material. The droplets may be configured to orient along the direction of the magnetic field when the magnetic field is applied statically, or when the magnet or sample is rotated.

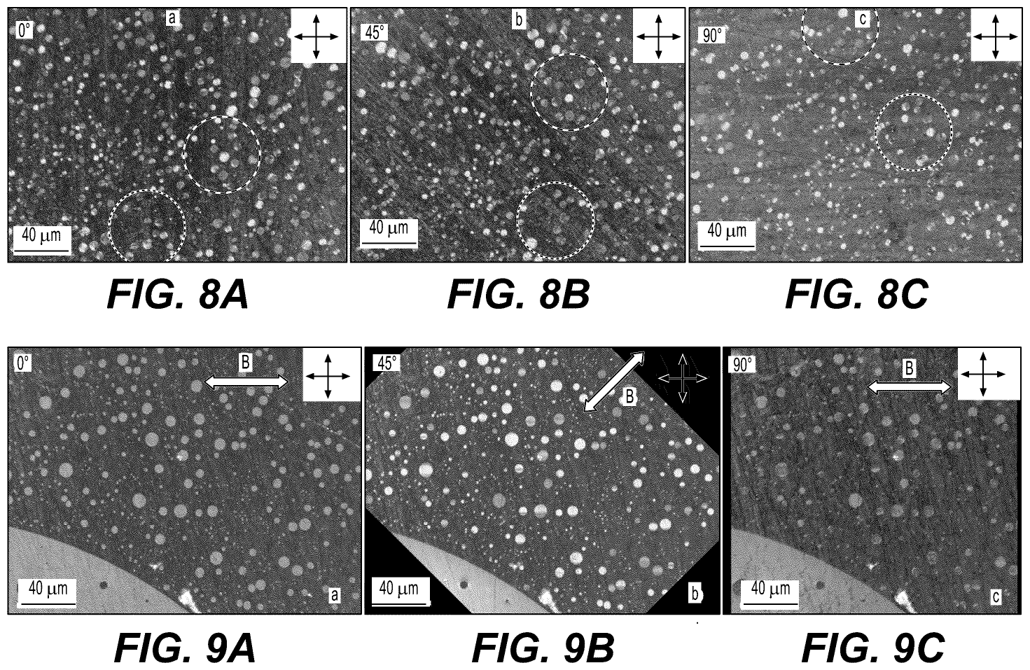

As illustrated in FIG. 10, two sets (each set having two samples) of samples were prepared in the absence of magnetic field to measure the alignment kinetics. The first set of samples was prepared by isothermally heating the as-prepared pitch material at 300° C. for 30 min. The second set of samples was prepared by two step thermal treatment. First, the as prepared material was isothermally heated for 30 min at 300° C., then subsequently pyrolyzed at 400° C. for 30 min to produce more mesophase. Both sets of samples showed random orientation of mesophase domains after this temperature treatment as evident in the 2D x-ray pattern. First set of samples were then heated to 400° C. with a heating rate of 20° C./min and in which one sample was held isothermal at that temperature for 1 min and the second one for 5 min. After this protocol, the sample was cooled to room temperature and x-ray scattering patterns were measured. Both samples showed similar degree of alignment for these short time scales (e.g., 1 min). The second set of samples were also subjected to similar experimental protocol, and they showed strong orientation even for 1 min isothermal soaking time at 400° C., suggesting that alignment can be achieved within short time scales (e.g., <1 min).

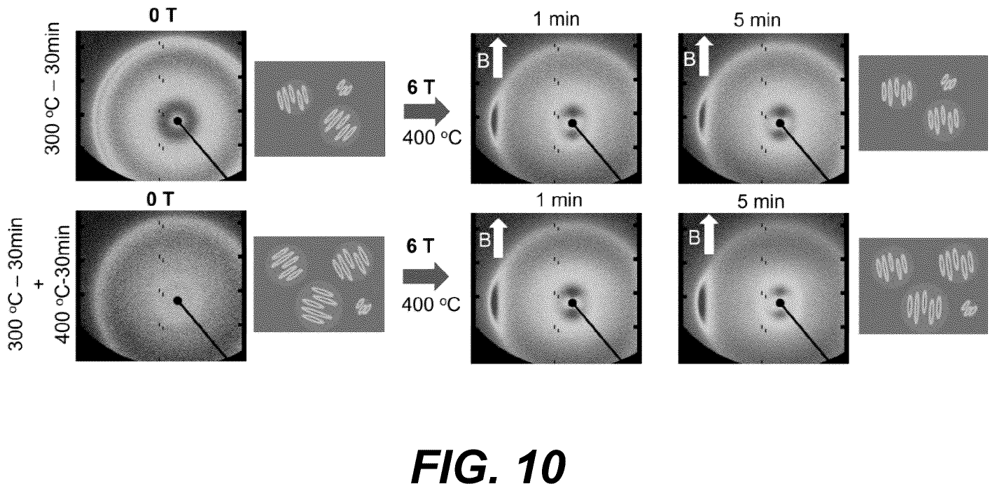

FIGS. 11A-11D illustrate a composite material with mesophase pitch. The discotic mesogen director orientation is random. As shown in FIG. 11A, when a mesophase is mixed with a polymerizable monomer system, wherein the mesophase pitch droplets may be made of mesophase alone or mesophase with some isotropic phase contained within it. Both are different compositions of matter. If an epoxy is then added, the epoxy can be cured before the mesophase is aligned because there is still isotropic phase that will give low enough viscosity for the mesophase droplet to reorient with respect to the magnetic field at higher temperatures (>Tₛ). However, if the material contains 100% mesophase droplets to begin with, the droplets should be aligned before the polymerizable monomer is cured to make the composite material, otherwise the mesophase material may not reorient in a cured epoxy. For this embodiment, mesophase can be aligned at lower temperatures (e.g., room temperature) with low intensity magnetic fields afforded by the low viscosity of the surrounding medium, e.g., monomer solvent.

As shown in FIG. 11B, when a magnetic field is applied at high temperatures (above the softening point of the matrix or the isotropic phase), the droplet orients along the field with its poles lying in a plane perpendicular to the magnetic field direction. As shown in FIGS. 11C-11D, when the magnet (or sample) is rotated, the director orients uniaxially to satisfy the energetic condition consistent with the magnetic anisotropy of discotic mesogens in the mesophase pitch.

To achieve faster rate of alignment of the mesophase domains or droplets along the magnetic field, the mesophase may have an average molecular spacing of between approximately 3.4 to 3.7 Å (e.g., approximately 3.4 Å, approximately 3.5 Å, approximately 3.6 Å, approximately 3.7 Å), and an average molecular size (multi-ring aromatics) of between approximately 1 to 3 nm (e.g., approximately 1.0 nm, approximately 1.5 nm, approximately 2.0, nm, approximately 2.5 nm, approximately 3.0 nm). When the mesophase domain or droplet size formed by the mesogenic characteristics is equal to or above a threshold size (e.g., 50 nm), the droplets may align quickly with the applied magnetic field, such as between approximately 0.1 to 104 seconds of applying the magnetic field (e.g., between approximately 0.01 to 60 minutes, or between approximately 0.01 to 30 minutes). In some embodiments, when the mesophase droplets reaches approximately 50 nm, the droplets may spontaneously align with the applied magnetic field.

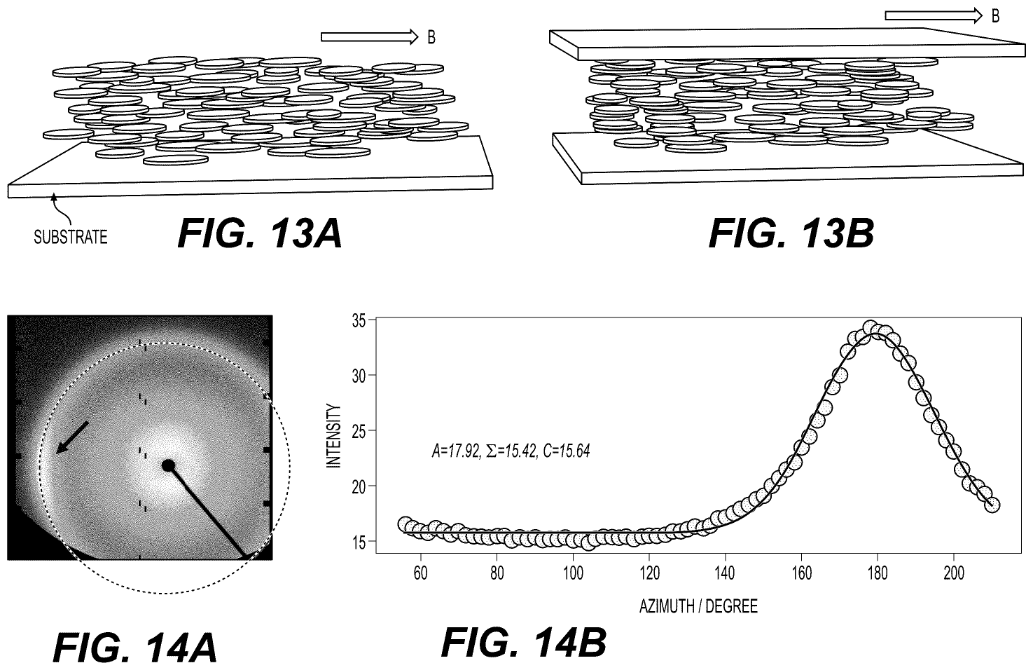

Additionally, pyrolysis may be conducted at high temperature (Tₛ<T_{Pyrolysis}≤475° C.) when the sample is subjected to the magnetic field. This leads to production of more mesogenic species depending on the reaction kinetics which is a function of temperature. Subsequently, mesogens diffuse, nucleate, and subsequently grow to form mesophase droplets with kinetics determined by the temperature dependent viscosity together with the thermodynamic transition temperature of the mesophase composition (T_{isotropie-nematic}≥T_{Pyrolysis}). When all these conditions are satisfied, the number density of mesophase droplets (i.e., the mesophase content) increases with time. In an embodiment as shown in FIG. 14B, the time dependence of mesophase content is presented for T_{Pyrolysis}=400° C. Further, using a higher mesophase-containing material (e.g., approximately 25-50% mesophase) may result in the mesophase droplets aligning more quickly when subjected to a magnetic field and when the temperature is in the range Tₛ<T_{Pyrolysis}≤475° C. (time scale depends on operating temperature and chemical composition of the material under consideration). The rate of alignment also depends on the magnetic anisotropy (number of aromatic rings in discotics) and applied field strength. For example, the higher the field strength, and at higher temperatures, faster alignment of mesophase may be achieved.

In a composite system (FIGS. 11B-11C), the mesophase pitch fraction can be between approximately 20-100% by volume, where for the highest mesophase content, the suspension medium/matrix should have an accessible softening point, preferably close to the softening point (or less) than the mesophase pitch. When the mesophase content is very high (e.g., greater than approximately 60%), then the kinetics of re-orientation of the mesophase domains (or droplets) within the medium is solely dependent on the operating temperature for a given composition (diamagnetic anisotropy ΔX) and field strength (B) in Equation 3, which needs be well above the softening point (or the solid-liquid crystal transition temperature) of the mesophase so that the viscosity is low enough for director re-orientation. However, if the mesophase pitch contains a higher fraction of isotropic domains (e.g., greater than approximately 50%), the lower viscosity imparted by the isotropic pitch matrix surrounding the mesophase material also provides low enough viscosity for the droplet re-orientation with poles lying perpendicular to the field axis, once the isotropic pitch component is above its softening point.

The suspending medium could be a polymer resin/monomer (with or without other additives), as a solvent, or isotropic pitch. The polymer resin should be of sufficiently low viscosity at the operating temperature to allow mesophase pitch particle alignment in short time scales, and upon achieving alignment, should be cured/polymerized quickly to lock in the particle orientation. It is possible that this composite of green mesophase particles (not carbonized) and the cured resin might have sufficiently improved properties over the neat polymer for use in certain non-load bearing applications. However, for high performance, the mesophase particles may need to be graphitized to achieve high stiffness. Mesophase particles may be thermally treated (stabilized, carbonized, or graphitized) before embedding in the resin leading to carbon-polymer composites with unique anisotropic properties. The graphite particles obtained from the mesophase pitch can also be incorporated into an isotropic pitch material and after magnetic alignment of the graphite crystalline particles (utilizing their crystalline magnetic anisotropy), the matrix isotropic material can be oxidatively stabilized to lock the orientation of the graphite particles. Further heat treatment may result in carbon-carbon material with unique anisotropic mechanical, electrical, or thermal properties. It would also be possible to 3D print carbon articles using the resin suspensions with mesophase pitch droplets while subjecting to a magnetic field at the nozzle to obtain structures with tunable morphology prescribed by the direction of magnetic field lines. In the solvent/polymer suspensions, the droplets may be magnetically aligned and allowed to coalesce and sediment into sheet-like structures with solvent evaporation. These structures may be graphitized to obtain larger graphitic sheets for use as coatings, reinforcement layers, etc.

Mesophase Pitch Material with CNTs

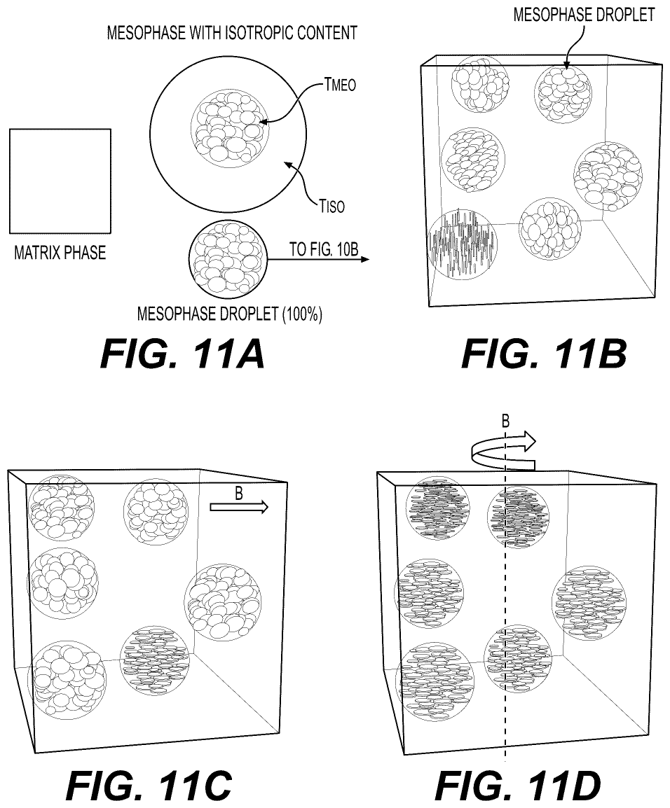

Magnetic control, as discussed herein, could be implemented for other systems, such as mesophase pitches with CNTs. CNTs also exhibit significant magnetic-susceptibility anisotropy with ΔX≈10⁻⁵ emu mol⁻¹. If CNTs can be dispersed in the thermotropic mesophase pitch, the composite material could form a co-existing two nematic states (e.g., with a CNT loading of approximately 3%): one formed by the mesophase pitch, the other one formed by the CNTs (once above a critical concentration). At lower concentrations of CNT (e.g., lower than approximately 1%), the orientation of the CNTs will be controlled by the interfacial energetics (anchoring condition of the discotic mesogen at the CNT interphase) and the magnetic anisotropy of the mesophase pitch. Since at higher concentrations (e.g., greater than approximately 3%) the CNT may also lead to a collective anisotropy, the orientation may be determined by the collective diamagnetic anisotropy of the CNTs and mesogens and the anchoring effects for a given field strength. Therefore, the orientation control of CNTs can be achieved by the application of an external field, as illustrated in FIG. 12, which shows a composite material containing CNTs and mesophase pitch. The material will be in a nematic liquid crystalline material above a softening point of the liquid crystal matrix. The orientation of the CNTs depends on the concentration and the anchoring effects of the mesophase molecules at the CNT interfaces. After high temperature thermal treatments, the graphitic domain size and orientation of graphitic basal planes in these carbonaceous pitch materials could be enhanced after alignment under high magnetic fields, consequently leading to improved mechanical properties.

### Droplet Texture Analysis

Defects or disclination lines may appear in the birefringent regions in liquid crystal (LC) systems including mesophase droplets due to differences in molecular orientation leading to a discontinuity (of the director vector) at the domain interface. The droplet morphology in LCs is determined by the quadratic function of the curvature strain and the three Frank elastic constants, K₁₁, K₂₂ and K₃₃, that captures the resistance of the mesophase to the splay, twist, and bend deformation modes. For mesophase systems, it is predicted that K₃₃>K₁₁, and also that the K₃₃/K₁₁ ratio can be reduced by introducing alkoxy side groups. The overall texture observed in each sample may also be affected by droplet coalescence and molecular mobility (viscosity). Shear effects acting on the system (volatile formation) during pyrolysis can also influence the texture in these systems. Due to diamagnetic anisotropy of the mesophase formed by discotic mesogens with director pointing normal to the plane of the molecules when a mesophase pitch droplet is subjected to an external magnetic field (above the threshold value), the layer planes should align in the direction of the field—so that the poles (region of singularities in the mesophase droplets) align degenerate in a plane perpendicular to the applied field. This is anticipated when the sample is heated above the glass transition temperature, T_{g}, of the isotropic surrounding material and above the softening point of the mesophase droplets. The alignment of the discotic mesogens in a magnetic field during the pyrolysis could substantially reduce the elastic distortion imparted by the droplet interphase once they are in contact, thereby enhancing the rate of droplet coalescence. This may have implications on the material processing at different mesophase contents (e.g., carbon fiber production).

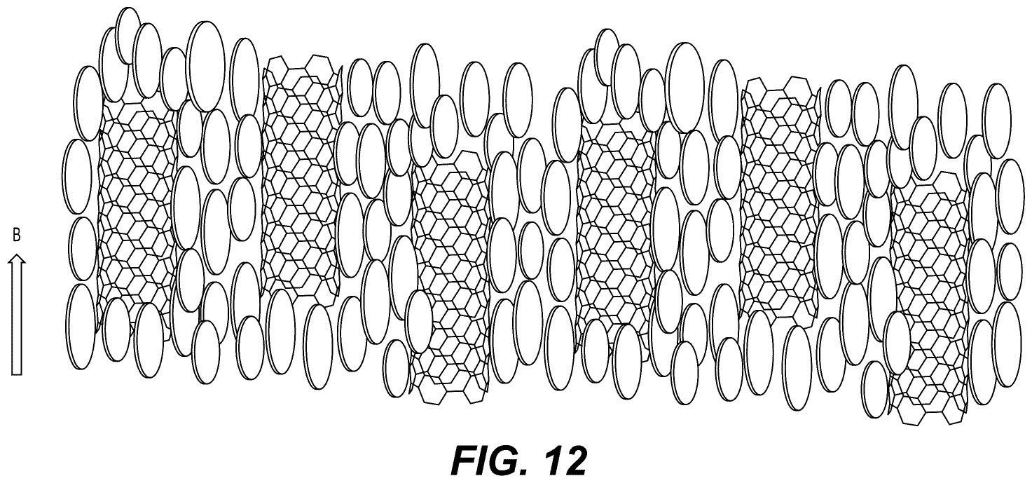

Droplet texture analysis of different feed materials in the presence of an external magnetic field has potential impact on the orientation of the molecules when subjected to concurrent fields (shear field, surface alignment and magnetic field) during material processing. Surface induced alignment of discotic mesogens can be combined with the application of a magnetic field to obtain large domain orientation in thin and thick films, both on supported films and sandwiched films, as shown in FIGS. 13A-13B. As shown in FIG. 13A, if the mesogens are aligned in plane relative to the surface, a magnetic field can be used to induce stronger alignment in thin or thicker films. Additionally, as shown in FIG. 13B, surface confinement can also enforce stronger alignment. Magnetic alignment can enforce alignment of discotic mesogen interfaces along the field (larger molecular axis). In addition, if the surface forces are such that it favors in-plane orientation, it can lead to stronger in-plane alignment. If the discotics align homeotropically at the substrate interface, and if the substrate interface is held parallel to the field direction during alignment processing, unique alignment of discotic director of the mesophase pitch parallel to the field axis can be obtained. Subsequent thermal treatments (e.g., oxidation, carbonization, and graphitization) could lead to enhanced graphitic domain size in thin films making these materials potentially useful for electrode or other composite applications.

### Estimation of Aligned Mesophase Fraction in Pitches by Magnetic Alignment

Estimation of mesophase fraction in pitches can be conducted with reflected polarized light microscopy, by estimating the area fraction covered by birefringent droplets or regions. The samples may be prepared by embedding in an epoxy matrix and polishing to get a mirror smooth surface to enhance image contrast (to minimize scattering under reflection). While this surface measurement technique is an industrial standard, an approach to estimate mesophase content in the bulk is not trivial. Embodiments of the present disclosure use magnetic alignment of the pitch to estimate mesophase fractions by the intensity contributions due to the oriented and unoriented fractions and the peak width of the molecular stacking (d(002)) reflection.

In some embodiments, where a higher mesophase content (e.g., approximately 30% to 60%) is achieved (FIG. 14B), applying a magnetic field may allow for measuring of the bulk mesophase fraction using x-ray scattering. In such examples, there may still exist isotropic fraction but with a molecular spacing not that far from mesophase, allowing for the bulk measurement of mesophase content. In some embodiments, this method may also be used to measure the aligned fraction of the mesophase or rate of mesophase formation, for example, when conducting pyrolysis on a pitch material at higher temperatures (Tₛ<T_{Pyrolysis}≤475° C.). A pre-made mesophase pitch when strongly aligned by magnetic fields allows estimation of the bulk mesophase content in the material.

A magnetically aligned sample was used for the data fitting purpose. FIG. 14A is a 2D data of the aligned mesophase sample, which was further analyzed to obtain the intensity against azimuthal angle representation as shown in FIG. 14B.

FIG. 14B illustrates the angular distribution of the wide-angle reflection that corresponds to the mesophase ordering peak at q˜1.8 Å⁻¹, modeled as a sum of Gaussian component and a constant component, according to the following equation:

$$I ( χ ) = A exp ( {( χ - μ )}^{2} / 2 {\sum }^{2} ) + C \qquad Equation 4$$

where the constant C is the background scattering intensity due to randomly aligned mesophase or isotropic domains (which has molecular spacing closer to mesophase reflection due to higher aromaticity).

The contributions from aligned or non-aligned fractions should be proportional to the integrated intensity of all orientations in q. The following equation can be used to estimate the contribution due to randomly oriented domains.

$${I}_{random} = 4 π {q}^{2} C \qquad Equation 5$$

The orientation part arises from face-face correlations of the disks. For “perfect” alignment the scattering would be a circle running around the equator, unlike a nematic, where perfect alignment would give a single orientation of the nematic director. If instead it is a “belt” of constant intensity, A, over a width ±Δθ, the following calculation can be used, in spherical coordinates,

$${I}_{oriented} = 2 π {q}^{2} A {\int }_{- ∞}^{∞} {e}^{- {x}^{2} / 2 {\sum }^{2}} = 2 {π}^{2} {q}^{2} \sum A \sqrt{2 π} ( in radians ) = \frac{2 {π}^{2} {q}^{2} \sum A \sqrt{2 π}}{180} ( in degrees ) \qquad Equation 6$$

$$R = \frac{{I}_{oriented}}{{I}_{random}} = \frac{π \sum A \sqrt{2 π}}{360 C} ≅ \frac{0.0 \; 22 \sum A}{C} \qquad Equation 7$$

The mesophase fraction may thus be calculated by:

$${f}_{meso} = \frac{{I}_{oriented}}{{I}_{oriented} + {I}_{random}} = \frac{R}{1 + R} \qquad Equation 8$$

For the data shown in FIG. 14B, the mesophase fraction is calculated as

$$R ≅ \frac{0.022 ( 15.42 ) ( 17.2 )}{15.64} = 0.37$$

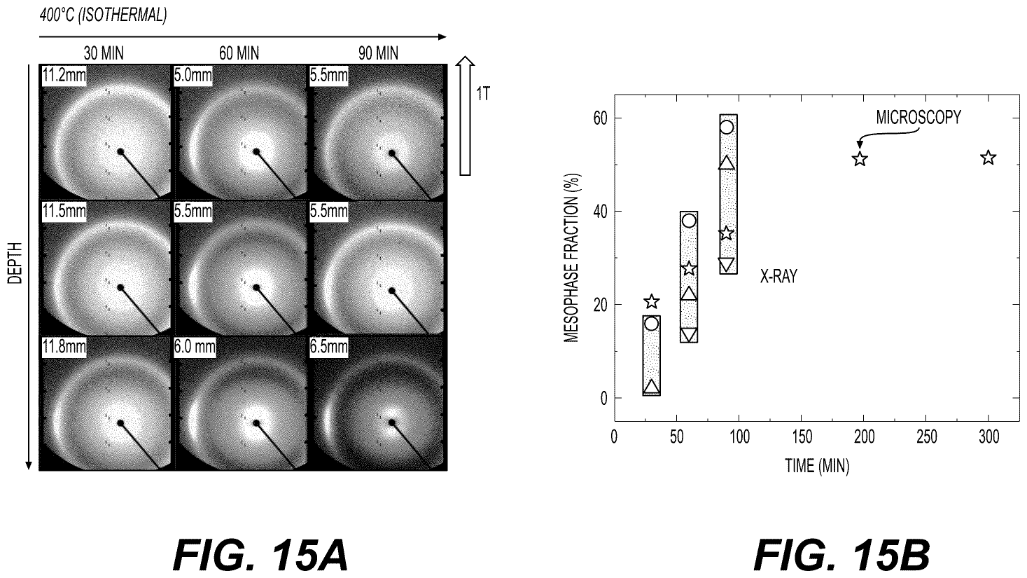

and fₘₑₛₒ as approximately 0.27, or approximately 27%. It was found that the mesophase fraction changes along the length of the capillary during pyrolysis where larger mesophase content was obtained towards the bottom of the capillary, as shown in FIGS. 15A-15B. This is possibly due to higher density of the mesophase material in comparison to isotropic part. This approach can be extended to shear aligned (spun) mesophase pitch fibers as well to estimate the aligned mesophase fraction in the as-spun fiber, and to changes due to further upstream high temperature processes, e.g., carbonization and graphitization.

FIG. 15A provides alignment quality as a function of depth (vertical axis) in the direction of magnetic field axis for a given annealing time (horizontal axis). FIG. 15B shows the bulk mesophase fraction estimated by Equation 8 (above) for different heights along the capillary. Highest mesophase content was observed near the bottom of the capillary. The data points denoted by star shapes represent the bulk mesophase content obtained by cross-polarized optical microscopy measurements wherein the samples were prepared in a high temperature oven operated under N₂ atmosphere, thus the sample preparation conditions were different for the latter samples.

### Mesophase Alignment Applications

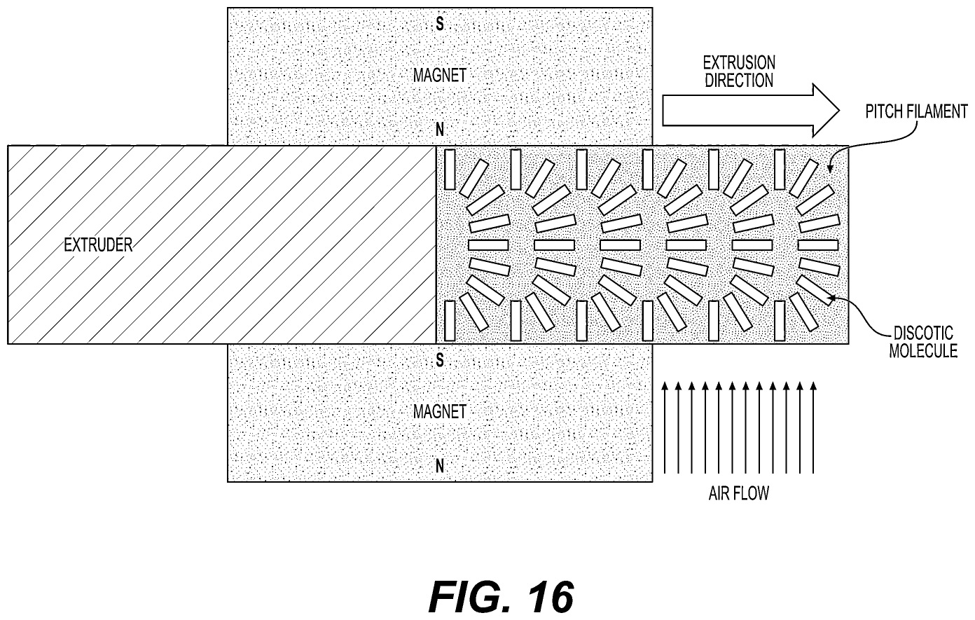

FIG. 16 provides an example of a scheme for inducing alignment of mesophase molecules in articles (e.g., fibers), during different applications, such as extrusion or 3D printing. As shown, magnets (having north (N) and south(S) poles) may be configured at the spinneret exit or output point of an extruder. Thus, as the pitch filament, containing the mesophase molecules, exits the extruder or spinneret (e.g., with air flowing in a direction perpendicular to the extrusion direction) orientation of the mesophase molecules can be achieved in the presence of the applied magnetic field.

### Additional Embodiments

Embodiment 1. A material, comprising: a composition comprising a mesophase pitch material of between approximately 5.0% to 95.0% and having a viscosity of between approximately 0.01 to 10² Pascal seconds (Pa·s) in a temperature range of between approximately Tₛ<T≤475° C., where Tₛ≥150° C., wherein at least a portion of the mesophase pitch material is aligned by a magnetic field having a strength of approximately 0.25 to 6.0 Tesla, and wherein the portion of the mesophase pitch material has an average molecular spacing between approximately 3.4 to 3.7 angstroms, and an average molecular size of between approximately 1 to 3 nanometers (nm).

Embodiment 2. A material according to Embodiment 1, wherein the magnetic field is approximately 1.0 Tesla, and wherein the portion of the mesophase pitch material has a minimum droplet diameter of approximately 50 nm and is aligned by the magnetic field at a temperature of between approximately 200° C. to 450° C., and within approximately 0.1 to 104 seconds of applying the magnetic field.

Embodiment 3. A material according to any of Embodiments 1-2, wherein the portion of the mesophase pitch material is aligned by the magnetic field between approximately 0.01 to 30 minutes of applying the magnetic field.

Embodiment 4. A material according to any of Embodiments 1-3, wherein a micro carbon residue test (MCRT) of the material is greater than approximately 40 percent.

Embodiment 5. A material according to any of Embodiments 1-4, wherein the composition further comprises a matrix phase and a plurality of mesophase droplets suspended in the matrix phase, and wherein the plurality of mesophase droplets is configured to be aligned by the magnetic field when the magnetic field is applied statically, by rotating a central magnetic field, or by rotating the material.

Embodiment 6. A material according to any Embodiments 1-5, wherein the composition further comprises one or more of a carbon/carbon composite, a carbon/polymer composite, a carbon nanotube (CNT) composite, or combinations thereof.

Embodiment 7. A lithium-ion battery anode comprising a material according to any Embodiments 1-6.

Embodiment 8. A material according to any Embodiments 1-7, wherein the composition has a molecular weight of between approximately 200 to 2000 g/mol.

Embodiment 9. A method for controlling the alignment of mesogenic molecules in a composition, the method comprising: providing the composition comprising a mesophase pitch material of between approximately 5.0% to 100.0% and having a viscosity of between approximately 0.01 to 102 Pascal seconds (Pa·s) in a temperature range of between approximately Tₛ<T≤475° C., where Tₛ≥150° C.; and applying a magnetic field of between approximately 0.25 to 6.0 Tesla to the composition thereby resulting in at least a portion of the mesophase pitch material being aligned by the magnetic field within approximately 0.1 to 104 seconds, wherein the portion of the mesophase pitch material comprises a plurality of mesophase droplets having a minimum droplet diameter of approximately 50 nanometers (nm).

Embodiment 10. A method according to Embodiment 9, wherein the magnetic field is approximately 1.0 Tesla, and wherein applying the magnetic field is conducted at a temperature of between approximately Tₛ<T≤475° C.

Embodiment 11. A method according to any of Embodiments 9-10, wherein the portion of the mesophase pitch material is aligned by the magnetic field between approximately 0.01 to 30 minutes.

Embodiment 12. A method according to any of Embodiments 9-11, wherein a micro carbon residue test (MCRT) of the composition is greater than approximately 40 percent.

Embodiment 13. A method according to any of Embodiments 9-12, wherein applying the magnetic field allows for measuring a bulk mesophase fraction or aligned mesophase fraction using 2-dimensional x-ray scattering.

Embodiment 14. A method according to any of Embodiments 9-13, wherein applying the magnetic field allows for optimizing a mesophase domain or a droplet size of the mesophase pitch material.

Embodiment 15. A method according to any of Embodiments 9-14, wherein applying the magnetic field is in a shear zone resulting in control of one or more fiber properties of the composition.

Embodiment 16. A material, comprising: a composition comprising a mesophase pitch material of between approximately 5.0% to 95.0% and having a viscosity of between approximately 0.01 to 102 Pascal seconds (Pa·s), wherein at least a portion of the mesophase pitch material is aligned by a magnetic field in the presence of the magnetic field of between approximately 0.5 to 2.0 Tesla at a temperature of between approximately Tₛ<T≤450° C., where Tₛ≥150° C., and within approximately 0.1 seconds to 50 minutes.

Embodiment 17. A material according to Embodiment 16, wherein the portion of the mesophase pitch material is aligned by the magnetic field between approximately 0.01 to 30 minutes.

Embodiment 18. A material according to any of Embodiments 16-17, wherein a micro carbon residue test (MCRT) of the material is greater than approximately 40 percent.

Embodiment 19. A material according to any of Embodiments 16-18, wherein the composition further comprises a matrix phase and a plurality of mesophase droplets suspended in the matrix phase, and wherein the plurality of mesophase droplets is configured to be aligned by the magnetic field when the magnetic field is applied statically, by rotating a central magnetic field, or by rotating the material.

Embodiment 20. A material according to any of Embodiments 16-19, wherein applying the magnetic field along with utilizing surface orientation allows for increasing molecular order of the material and graphitic domain size of the material after stabilization, carbonization, and graphitization.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present methodologies. Additionally, the disclosure shows and describes exemplary methods, but it is to be understood that various other combinations, modifications, and environments may be employed, and the present methods are capable of changes or modifications within the scope of the concept as expressed herein, commensurate with the above teachings and/or the skill or knowledge of the relevant art.

What is claimed is:

1. A material, comprising:
a composition comprising a mesophase pitch material of between approximately 5.0% to 95.0% and having a viscosity of between approximately 0.01 to 102 Pascal seconds (Pa·s) in a temperature range of between approximately Tₛ<T≤475° C., where Tₛ≥150° C.,
wherein at least a portion of the mesophase pitch material is aligned by a magnetic field having a strength of approximately 0.25 to 6.0 Tesla, and
wherein the portion of the mesophase pitch material has an average molecular spacing between approximately 3.4 to 3.7 angstroms, and an average molecular size of between approximately 1 to 3 nanometers (nm).

2. The material of claim 1, wherein the magnetic field is approximately 1.0 Tesla, and wherein the portion of the mesophase pitch material has a minimum droplet diameter of approximately 50 nm and is aligned by the magnetic field at a temperature of between approximately Tₛ<T≤450° C., and within approximately 0.1 to 104 seconds of applying the magnetic field.

3. The material of claim 1, wherein the portion of the mesophase pitch material is aligned by the magnetic field between approximately 0.01 to 30 minutes of applying the magnetic field.

4. The material of claim 1, wherein a micro carbon residue test (MCRT) of the material is greater than approximately 40 percent.

5. The material of claim 1, wherein the composition further comprises a matrix phase and a plurality of mesophase droplets suspended in the matrix phase, and wherein the plurality of mesophase droplets is configured to be aligned by the magnetic field when the magnetic field is applied statically, by rotating a central magnetic field, or by rotating the material.

6. The material of claim 1, wherein the composition further comprises one or more of a carbon/carbon composite, a carbon/polymer composite, a carbon nanotube (CNT) composite, or combinations thereof.

7. A lithium-ion battery anode comprising the material of claim 1.

8. The material of claim 1, wherein the composition has a molecular weight of between approximately 200 to 2000 g/mol.

9. A method for controlling the alignment of mesogenic molecules in a composition, the method comprising:
providing the composition comprising a mesophase pitch material of between approximately 5.0% to 100.0% and having a viscosity of between approximately 0.01 to 102 Pascal seconds (Pa·s) in a temperature range of between approximately Tₛ<T≤475° C., where Tₛ≥150° C.; and
applying a magnetic field of between approximately 0.25 to 6.0 Tesla to the composition thereby resulting in at least a portion of the mesophase pitch material being aligned by the magnetic field within approximately 0.1 to 10⁴ seconds,
wherein the portion of the mesophase pitch material comprises a plurality of mesophase droplets having a minimum droplet diameter of approximately 50 nanometers (nm).

10. The method of claim 9, wherein the magnetic field is approximately 1.0 Tesla, and wherein applying the magnetic field is conducted at a temperature of between approximately Tₛ<T≤475° C.

11. The method of claim 9, wherein the portion of the mesophase pitch material is aligned by the magnetic field between approximately 0.01 to 30 minutes.

12. The method of claim 9, wherein a micro carbon residue test (MCRT) of the composition is greater than approximately 40 percent.

13. The method of claim 9, wherein applying the magnetic field allows for measuring a bulk mesophase fraction or aligned mesophase fraction using 2-dimensional x-ray scattering.

14. The method of claim 9, wherein applying the magnetic field allows for optimizing a mesophase domain or a droplet size of the mesophase pitch material.

15. The method of claim 9, wherein applying the magnetic field is in a shear zone resulting in control of one or more fiber properties of the composition.

16. A material, comprising:
a composition comprising a mesophase pitch material of between approximately 5.0% to 95.0% and having a viscosity of between approximately 0.01 to 102 Pascal seconds (Pa·s),
wherein at least a portion of the mesophase pitch material is aligned by a magnetic field in the presence of the magnetic field of between approximately 0.5 to 2.0 Tesla at a temperature of between approximately Tₛ<T≤450° C., where Tₛ≥150° C., and within approximately 0.1 seconds to 50 minutes.

17. The material of claim 16, wherein the portion of the mesophase pitch material is aligned by the magnetic field between approximately 0.01 to 30 minutes.

18. The material of claim 16, wherein a micro carbon residue test (MCRT) of the material is greater than approximately 40 percent.

19. The material of claim 16, wherein the composition further comprises a matrix phase and a plurality of mesophase droplets suspended in the matrix phase, and wherein the plurality of mesophase droplets is configured to be aligned by the magnetic field when the magnetic field is applied statically, by rotating a central magnetic field, or by rotating the material.

20. The material of claim 16, wherein applying the magnetic field along with utilizing surface orientation allows for increasing molecular order of the material and graphitic domain size of the material after graphitization.
